(19) United States
(12) Patent Application Publication
(10) Pub. No.: US 2026/0056829 A1
(43) Pub. Date: Feb. 26, 2026

(54) EFFICIENT AND SECURE PROCESSOR HEALTH MONITORING

(71) Applicant: QUALCOMM Incorporated, San Diego, CA (US)

(72) Inventors: Dinesh Kumar CHOUDHARY, Tonk (IN); Philip Geoffrey DERRIN, Beecroft (AU); Maulik SHAH, Hyderabad (IN)

(21) Appl. No.: 18/812,103

(22) Filed: Aug. 22, 2024

(51) Int. Cl. G06F 11/07; G06F 13/24

(52) U.S. Cl. CPC G06F 11/0793; G06F 11/0721; G06F 13/24

(57) ABSTRACT

Certain aspects of the present disclosure provide techniques and apparatus for processor health monitoring. Embodiments include receiving, by a bootstrap processor (BSP) core of a computing system after expiration of a timer, an interrupt from a monitoring component executing in secure firmware of the computing system. Embodiments include transmitting, by the BSP core based on the receiving of the interrupt, interrupts to a plurality of processor cores of the computing system. Embodiments include performing, by the BSP core, one of: resetting the timer if the BSP core receives acknowledgments from the plurality of processor cores in response to the interrupts; or triggering a fault handling process if the BSP core does not receive an acknowledgment from one of the plurality of processor cores.

### INTRODUCTION

Aspects of the present disclosure relate to monitoring health of processor cores in a computing system.

A computing system such as a “system-on-a-chip” or “SoC” may include multiple processor cores corresponding to one or more processors. Such a computing device may be, for example, a portable computing device (“PCD”), such as a laptop or palmtop computer, a cellular telephone or smartphone, portable digital assistant, portable game console, etc. An SoC is an example of one such system that integrates numerous components to provide system-level functionality. For example, an SoC may include one or more types of processors, such as central processing units (“CPU”), graphics processing units (“GPU”), digital signal processors (“DSP”), and neural processing units (“NPU”). An SoC may include other processing subsystems, such as a transceiver or “modem”subsystem that provides wireless connectivity, a memory subsystem, etc.

A system such as an SoC may also run virtual machines (VMs) or other virtual computing instances (VCIs) such as containers via a hypervisor that abstracts hardware resources such as processing and memory resources of the system. A VM, for example, may be executed via a virtual central processing unit (VCPU), which is a software construct that runs on an underlying physical processor core, such as being a thread running on such a core.

Monitoring health of processor cores in a system such as an SoC can be challenging due to the complexities of such a system. Some existing monitoring techniques, for example, involve each of multiple VMs monitoring the health of the processor cores on which they run, such as by issuing interrupts to corresponding VCPUs. Such techniques often involve redundant monitoring of cores by multiple VMs, and thus may be resource-intensive due to the large amounts of interrupts that are sent and handled. Furthermore, such techniques may involve gaps in monitoring due to the non-secure execution level(s) at which VMs typically run, and may fail to detect problems occurring at secure execution levels such as the physical core level. While existing monitoring techniques involve some monitoring at a secure execution level, such monitoring is typically limited to one or more particular cores such as a boot strap processor (BSP) core, and issues arising at secure execution levels on other cores are not detected by such monitoring.

Accordingly, there is a need in the art for improved techniques of monitoring the health of processor cores in a computing system.

### BRIEF SUMMARY

Certain aspects provide a method, comprising: receiving, by a bootstrap processor (BSP) core of a computing system after expiration of a timer, an interrupt from a monitoring component executing in secure firmware of the computing system; transmitting, by the BSP core based on the receiving of the interrupt, interrupts to a plurality of processor cores of the computing system; and performing, by the BSP core, one of: resetting the timer if the BSP core receives acknowledgments from the plurality of processor cores in response to the interrupts; or triggering a fault handling process if the BSP core does not receive an acknowledgment from one of the plurality of processor cores.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain features of one or more aspects of the present disclosure and are therefore not to be considered limiting of the scope of this disclosure.

FIG. 1 illustrates an example of computing components related to processor health monitoring according to various aspects of the present disclosure.

FIG. 2 illustrates an example of a system boot-up process related to processor health monitoring.

FIG. 3 illustrates an example of a virtual machine implemented processor health monitoring process.

FIG. 4 illustrates an example of a secure firmware implemented processor health monitoring process.

FIG. 5 illustrates an example of an enhanced system boot-up process related to processor health monitoring, according to various aspects of the present disclosure.

FIG. 6 illustrates an example of an enhanced secure firmware implemented processor health monitoring process, according to various aspects of the present disclosure.

FIG. 7 is a flow diagram depicting an example method of processor health monitoring, according to various aspects of the present disclosure.

FIG. 8 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and computer-readable mediums for processor health monitoring.

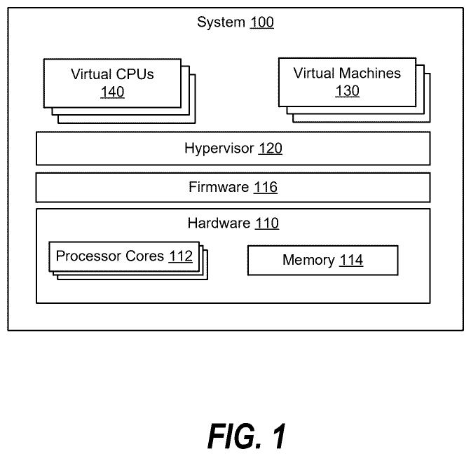

As described in more detail below with respect to FIG. 1, a computing system such as a system-on-a-chip (SoC) may include multiple virtual machines (VMs) running via virtual central processing units (VCPUs) that abstract (e.g., through operation of a hypervisor) physical processing resources of the system, such as cores of one or more physical processors.

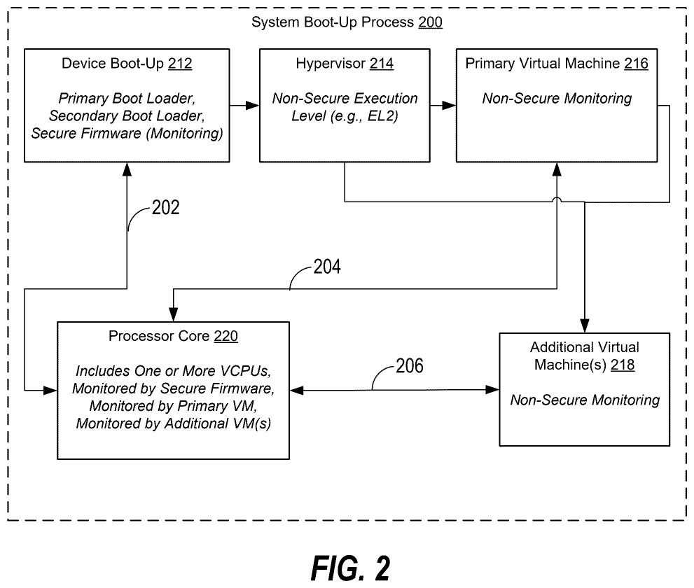

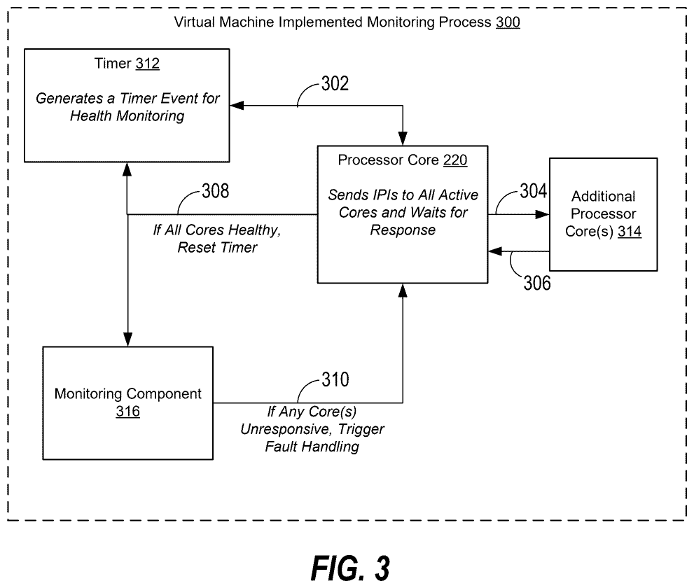

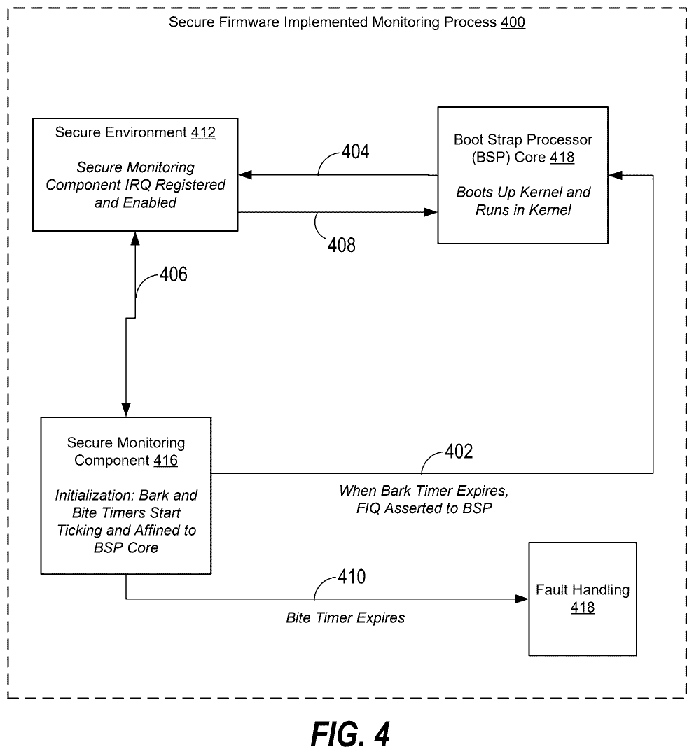

As described in more detail below with respect to FIGS. 2 and 3, existing techniques for monitoring processor health in such systems generally involve multiple VMs monitoring health of processor cores (e.g., via VCPUs running on the processor cores) at a non-secure execution level. While some existing techniques involve limited monitoring at a secure firmware level, as described in more detail below with respect to FIG. 4, such existing techniques do not monitor all active cores but instead monitor one or more targeted cores such as a boot strap processor (BSP) core at the secure firmware level. Thus, existing processor health monitoring techniques involve redundant non-secure monitoring of processor cores by multiple VMs, resulting in frequent interrupts and thereby decreasing system performance, and do not monitor all active processor cores at a secure execution level, allowing for the possibility of failing to detect issues with cores that occur at a secure execution level.

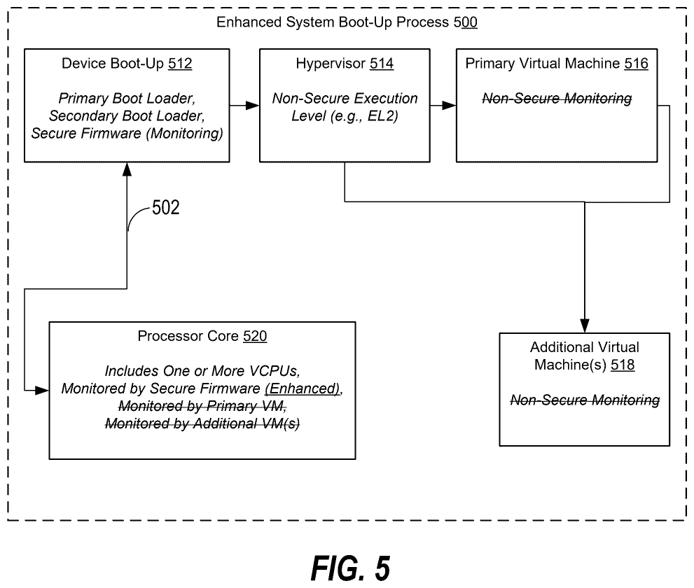

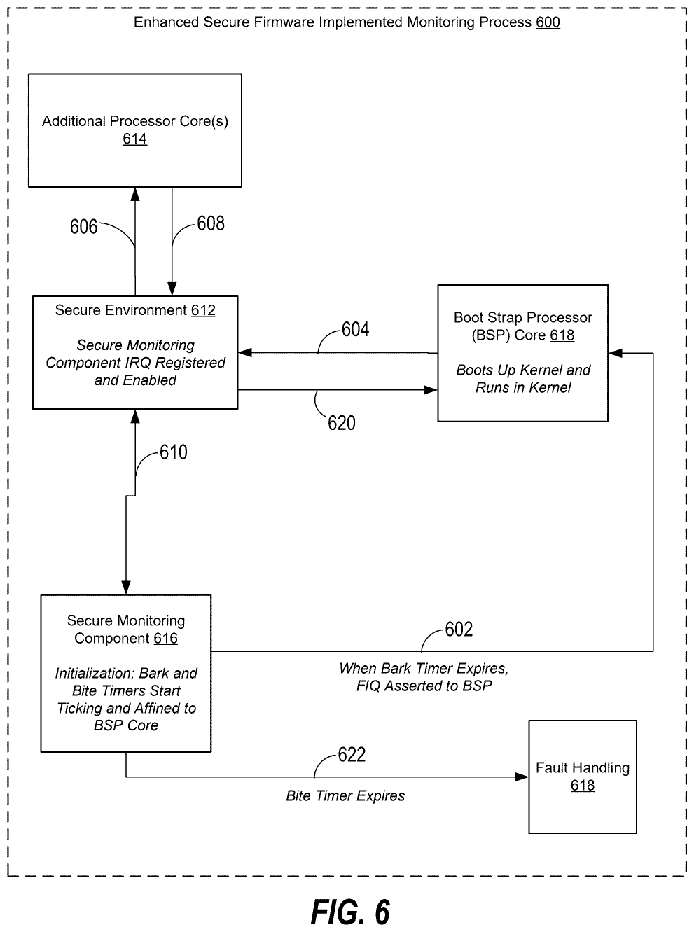

Techniques described herein overcome these challenges through an enhanced secure firmware implemented processor health monitoring technique. As described in more detail below with respect to FIG. 5, non-secure monitoring of core health by multiple VMs may be replaced with a single core health monitoring process at the secure firmware level that monitors health of all active processor cores. As described in more detail below with respect to FIG. 6, a monitoring component running at a secure execution level in firmware of the system may maintain a “bark” timer and a “bite” timer. Upon expiration of the bark timer, the monitoring component may send a fast interrupt request (FIQ) to the BSP core of the system, and the BSP core may send inter-processor interrupts (IPIs) to all active cores other than the BSP core. The BSP core may wait for acknowledgments from all of the active cores to which IPIs were sent and, if all expected acknowledgments are received, may notify the monitoring component to reset the bark timer (e.g., and the bite timer). If the bite timer expires without the BSP core having received an acknowledgment from at least one of the active cores, then the monitoring component may initiate a fault handling process, which may involve resetting the system.

Techniques described herein provide various technical improvements with respect to existing processor health monitoring implementations. For example, by avoiding the non-secure monitoring of processor cores by multiple VMs of prior techniques, aspects of the present disclosure avoid redundant monitoring, reduce the frequency of interrupts, reduce the utilization of computing resources associated with such redundant monitoring, and thereby improve system performance. For example, if one core has five VCPUs associated with it and those five VCPUs are associated with five different VMs, then those five VMs will all redundantly monitor the same core (and, in some cases, multiple additional cores) in prior techniques. Aspects of the present disclosure avoid such redundancy and inefficiency.

Furthermore, by monitoring the health of all active processor cores through a single monitoring process that is performed at a secure execution level, techniques described herein close the monitoring gaps present in prior monitoring techniques and ensure that the health of all active cores is monitored in such a manner as to detect issues that occur at both secure and non-secure execution levels. Rather than only monitoring one or more targeted cores such as a BSP core at a secure execution level as in prior techniques, aspects of the present disclosure involve monitoring of all active cores at a secure execution level. As an additional benefit, techniques described herein enable monitoring of the health of all active cores in a manner that prevents tampering with such monitoring logic due to the monitoring being implemented at the secure firmware level. Thus, aspects of the present disclosure may enable monitoring of compliance with licenses and/or other use restrictions (e.g., that limit a user or environment to a maximum number of active cores) in a tamper-proof manner.

FIG. 1 illustrates an example of computing components related to processor health monitoring according to various aspects of the present disclosure.

A system 100 is generally representative of a computing system such as a host computing device, and may be an SoC in certain implementations.

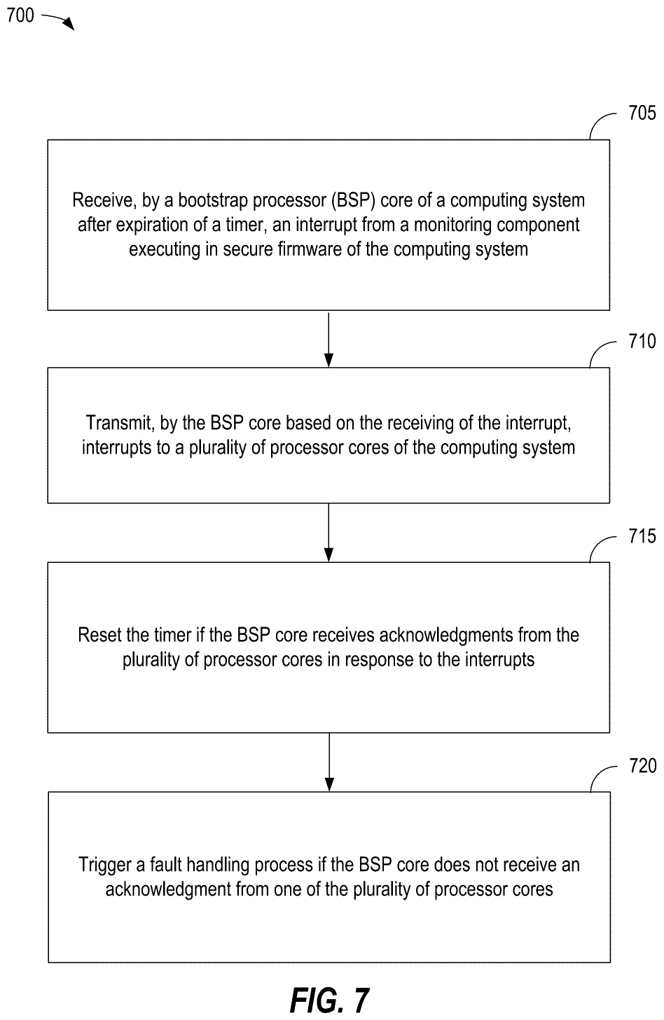

System 100 includes hardware 110, which includes multiple processors 112 and memory 115. Memory 114 generally represents physical storage resources, and may include volatile and/or non-volatile storage resources. For example, memory 114 may include one or more physical storage devices that enable storage and retrieval of data. Processor cores 112 generally represent physical processing devices, such as cores of central processing units (“CPU”) and/or cores of other types of processors such as graphics processing units (“GPU”), digital signal processors (“DSP”), neural processing units (“NPU”), and/or the like. In some embodiments, one or more of processor cores 112 may execute instructions stored in memory 114 in order to cause system 100 to perform aspects of functionality described herein, such as method 700 of FIG. 7.

System 100 further includes firmware 116, which generally represents software that provides low-level control of computing device hardware. Firmware 116 may run at a secure execution level, and may be configured to implement aspects of core health monitoring techniques described herein.

System 100 further includes a hypervisor 120, which “virtualizes” or abstracts resources in hardware 110 of system 100 for use by one or more virtual machines (VMs) 130 that execute via one or more virtual CPUs (VCPUs) 140. For example, hypervisor 120 may configure VCPUs 140 to utilize processing resources of particular processor cores 112, and may associate (or “affine”) each VM 130 to one or more VCPUs 140. A given VCPU 140 may be associated with one or more VMs 130, though the given VCPU 140 may execute operations of a single VM 130 at a time. Each VM 130 may be allocated storage resources from memory 114 by hypervisor 120, such as in the form of one or more virtual storage devices. VMs 130 generally run at a non-secure execution level.

Execution levels generally provide a context in which a given component performs operations, and define the scope of actions that the given component is authorized to perform. A component running at a secure execution level is authorized to perform a larger scope of actions and is generally more protected from tampering than a component running at a non-secure execution level. For example, the advanced reduced instruction set computer (RISC) machines (ARM) architecture includes four execution levels, which are (in increasing order of privilege) exception level 0 (EL0), exception level 1 (EL1), exception level 2 (EL2), and exception level 3 (EL3). EL0 is a generally non-secure execution level that is generally used for applications. EL1 is a generally non-secure execution level that is generally used for operating system (OS) kernels and associated functions that are generally described as privileged. In some cases, there is a secure version of EL1 that includes a higher privilege level than the typical EL1. EL2 is a generally non-secure execution level that is generally used for hypervisors. EL3 is a secure execution level that is generally used for firmware and secure monitoring.

In certain aspects, firmware 116 may run at EL3, hypervisor 120 may run at EL2, an OS kernel (e.g., running on one or more VMs 130) and/or otherwise running on system 100 may run at EL1, and VMs 130 may otherwise (e.g. when not performing OS kernel functionality) run at EL0.

As described in more detail below with respect to FIGS. 2-8, health of processor cores 112 may be monitored through various techniques, such as involving secure monitoring by firmware 116 and/or non-secure monitoring by VMs 130. Monitoring the health of processor cores 112 may enable fault handling operations to be performed, such as resetting system 100 if a processor core 112 is determined to be unhealthy (e.g., non-responsive). Limitations of existing monitoring techniques are described with respect to FIGS. 2-4 and enhanced monitoring techniques that overcome these limitations are described with respect to FIGS. 5-8.

### Example System Boot-up Process for Processor Health Monitoring

FIG. 2 illustrates an example of a system boot-up process 200 related to processor health monitoring. For example, system boot-up process 200 may relate to boot-up of system 100 of FIG. 1.

Device boot-up 212 may involve execution of a primary boot loader, a secondary boot loader, and secure firmware (which may perform certain core health monitoring functionality). For example, the primary boot loader may launch the secondary boot loader, and the secondary boot loader may initialize a secure environment in which secure firmware executes. The secure firmware executed at device boot-up 212 may perform limited secure monitoring of one or more target cores, such as including monitoring processor core 220 (which may be one of processor cores 112 of FIG. 1) at 202. In one example, the secure firmware monitors a BSP core (e.g., processor core 220 may be a BSP core).

The monitoring performed by the secure firmware at 202 is described in more detail below with respect to FIG. 4, and may involve a secure monitoring component sending an interrupt (e.g., FIQ) to processor core 220 and a fault handling process being triggered if processor core 220 does not acknowledge the interrupt before expiration of a bite timer (otherwise, if processor core 220 acknowledges the interrupt, one or more timers may be reset).

Device boot-up 212 may cause initialization of hypervisor 214 (which may be representative of hypervisor 120 of FIG. 1) at a non-secure execution level (e.g., EL2), which may cause execution of a primary VM 216. Hypervisor 214 and/or primary VM 216 may cause execution of one or more additional VMs 218, which may include one or more secondary VMs of one or more types. For example, one or more of additional VM(s) 218 may be initiated by primary VM 216 (e.g., with the involvement of hypervisor 214) and/or one or more of additional VM(s) 218 may be initiated by hypervisor 214.

Primary VM 216 may perform non-secure monitoring of processor core 220 at 204 and each of additional VM(s) 218 may perform non-secure monitoring of processor core 220 at 206. The monitoring performed by primary VM 216 and additional VM(s) 218 at 204 and 206 is described in more detail below with respect to FIG. 3, and may involve a given VM sending an interrupt to processor core 220, processor core 220 sending interrupts to one or more additional processor cores, and a fault handling process being triggered if one or more processor cores do not acknowledge an interrupt before expiration of a bite timer (otherwise, if all processor cores acknowledge corresponding interrupts, one or more timers may be reset). Thus, the monitoring performed by primary VM 216 and additional VM(s) 218 may involve redundant non-secure monitoring of processor core 220 and one or more additional processor cores (e.g., all active processor cores).

### Example VM Implemented Process for Processor Health Monitoring

FIG. 3 illustrates an example of a VM implemented monitoring process 300 related to processor health monitoring. For example, VM implemented monitoring process 300 may relate to system 100 of FIG. 1, and may correspond to monitoring performed at 204 and/or 206 of FIG. 2. VM implemented monitoring process 300 includes processor core 220 of FIG. 2.

VM implemented monitoring process 300 involves a timer 312, which generates a timer event for processor core health monitoring. For example, timer 312 may comprise a bark timer and, when the bark timer expires, this may cause an interrupt to be sent by a VM (e.g., primary VM 216 or an additional VM 218 of FIG. 2) to processor core 220 at 302 (e.g., processor core 220 may be registered to receive timer events generated by timer 312). In certain aspects, processor core 220 may run a VCPU that is assigned to the VM that performs VM implemented monitoring process 300 (e.g., the VCPU running on processor core 220 may the primary processing entity for the VM).

Upon receiving the interrupt at 302, processor core 220 may send interrupts, such as inter-processor interrupts (IPIs) to all active cores other than processor core 220 and wait for responses from the active cores acknowledging the interrupts. For example, at 304, processor core 220 may send an interrupt to each of one or more additional processor cores 314. Additional processor core(s) 314 may correspond to one or more of processor cores 112 of FIG. 1, and may represent all active processor cores in the system other than processor core 220. One or more of additional processor core(s) 314 may respond to processor core 220 with an acknowledgment of such an interrupt at 306. If processor core 220 and all of additional processor core(s) 314 acknowledge the corresponding interrupts (e.g., before expiration of a bite timer), then, at 308, processor core 220 may reset timer 312 (or processor core 220 may notify monitoring component 316 that all cores have responded and monitoring component 316 may reset timer 312) and operations at the VM may proceed until the next expiration of timer 312 (at which point VM implemented monitoring process 300 may be performed again).

If any core is unresponsive, then a fault handling process may be triggered by monitoring component at 316. For example, if processor core 220 does not respond to the interrupt sent at 302 with an acknowledgment or if any of additional processor core(s) 314 do not respond to the interrupt(s) sent at 304 with an acknowledgment before expiration of a bite timer, then monitoring component 316 may trigger a fault handling process at 310, which may involve resetting the system and/or notifying one or more other components that perform fault handling operations. For example, the bite timer may be started at the same time as the bark time and may be longer than the bark timer (or may be started at the time the bark timer expires).

VM implemented monitoring process 300 may be performed by multiple VMs, and thus may result in redundancy and large amounts of interrupts. Furthermore, VM implemented monitoring process 300 may be performed at a non-secure execution level, and thus may not detect issues that occur at a secure execution level, such as at the physical core level (e.g., issues at the EL3 or secure EL1 level). A VM executing at a non-secure execution level cannot monitor a component at a secure execution level (e.g., because a non-secure execution environment generally cannot send an interrupt to a secure execution environment), thus resulting in monitoring gaps.

### Example Secure Firmware Implemented Process for Processor Health Monitoring

FIG. 4 illustrates an example of a secure firmware implemented monitoring process 400 related to processor health monitoring. For example, secure firmware implemented monitoring process 400 may relate to system 100 of FIG. 1, and may correspond to monitoring performed at 202 of FIG. 2.

In secure firmware implemented monitoring process 400, a secure monitoring component 416, such as running in firmware 116 of FIG. 1, initializes bark and bite timers and associates (e.g., affines) these timers to boot strap processor (BSP) core 418 (e.g., which may correspond to processor core 220 of FIG. 2).

When the bark timer expires, secure monitoring component 416 may issue an interrupt (e.g., an FIQ) to BSP core 418 at 402. BSP core 418, which may boot up the kernel and run in the kernel, may halt operations in the kernel upon receiving the interrupt, and may switch to a secure environment 412 at 404. For example, 404 may represent a context switch performed by BSP core 418, such as from a non-secure execution level (e.g., EL0 or EL1) to a secure execution level (e.g., EL3).

At 406, BSP core 418 running in secure environment 412 may handle the interrupt that it received at 402, such as sending an acknowledgment to secure monitoring component 416. Assuming that an acknowledgment is sent at 406, then BSP core 418 may switch back to its prior execution level (e.g., a context switch from EL3 to EL0 or EL1) at 408, resuming execution in the kernel. Otherwise, if secure monitoring component 416 does not receive an acknowledgment in response to the interrupt prior to expiration of the bite timer, then secure monitoring component 416 may trigger fault handling 418 at 410. Fault handling 418 may involve, for example, resetting the system and/or notifying one or more other components that perform fault handling operations.

While secure firmware implemented monitoring process 400 allows one core (e.g., BSP core 418) to be monitored at a secure execution level, other active cores will not be monitored at a secure execution level in secure firmware implemented monitoring process 400.

### Example Enhanced System Boot-up Process for Processor Health Monitoring

FIG. 5 illustrates an example of an enhanced system boot-up process 500 related to processor health monitoring. For example, enhanced system boot-up process 500 may relate to boot-up of system 100 of FIG. 1, and may be an enhanced version of system boot-up process 200 of FIG. 2 that overcomes technical challenges associated prior techniques.

Device boot-up 512 may involve execution of a primary boot loader, a secondary boot loader, and secure firmware (which may perform certain core health monitoring functionality). For example, the primary boot loader may launch the secondary boot loader, and the secondary boot loader may initialize a secure environment in which secure firmware executes. The secure firmware executed at device boot-up 512 may perform enhanced secure monitoring of active cores, such as corresponding to processor cores 112 of FIG. 1, at 502. In certain aspects, the secure firmware monitors all active cores, such as via a BSP core (e.g., processor core 520 may be a BSP core).

The monitoring performed by the secure firmware at 502 is described in more detail below with respect to FIG. 6, and may involve a secure monitoring component sending an interrupt (e.g., FIQ) to processor core 520, prompting processor core 520 to send interrupts (e.g., IPIs) to all active cores other than processor core 520. A fault handling process may be triggered if any active core does not acknowledge a corresponding interrupt before expiration of a bite timer (otherwise, if all active cores acknowledge a corresponding interrupt, one or more timers may be reset).

Device boot-up 512 may cause initialization of hypervisor 514 (which may be representative of hypervisor 120 of FIG. 1) at a non-secure execution level (e.g., EL2), which may cause execution of a primary VM 516. Hypervisor 514 and/or primary VM 516 may cause execution of one or more additional VMs 518, which may include one or more secondary VMs of one or more types. For example, one or more of additional VM(s) 518 may be initiated by primary VM 516 (e.g., with the involvement of hypervisor 514) and/or one or more of additional VM(s) 518 may be initiated by hypervisor 514.

Unlike in system boot-up process 200 of FIG. 2, primary VM 516 does not perform non-secure monitoring of processor core 520 (as indicated by the strikethrough) or any other cores and additional VM(s) 518 do not perform non-secure monitoring of processor core 520 or any other cores (as indicated by the strikethrough).

Thus, enhanced system boot-up process 500 reduces interrupts and computing resource utilization by avoiding redundant non-secure monitoring of processor cores by multiple VMs. Furthermore, by performing an enhanced secure monitoring process that monitors all active cores at a secure execution level (e.g., in the secure firmware) instead of only monitoring one or more targeted cores such as a BSP core at a secure execution level, enhanced system boot-up process 500 closes monitoring gaps that exist in prior techniques and enables detection and handling of issues at all execution levels across all active cores in an efficient manner.

### Example Enhanced Secure Firmware Implemented Process for Processor Health Monitoring

FIG. 6 illustrates an example of an enhanced secure firmware implemented monitoring process 600 related to processor health monitoring. For example, enhanced secure firmware implemented monitoring process 600 may relate to system 100 of FIG. 1, and may correspond to monitoring performed at 502 of FIG. 5. According to certain aspects, enhanced secure firmware implemented monitoring process 600 may represent an enhanced version of secure firmware implemented monitoring process 400 of FIG. 4 that monitors all active cores instead of only monitoring one or more targeted cores.

In enhanced secure firmware implemented monitoring process 600, a secure monitoring component 616, such as running in firmware 116 of FIG. 1, initializes bark and bite timers and associates (e.g., affines) these timers to boot strap processor (BSP) core 618 (e.g., which may correspond to processor core 520 of FIG. 5).

When the bark timer expires, secure monitoring component 616 may issue an interrupt (e.g., an FIQ) to BSP core 618 at 602. BSP core 618, which may boot up the kernel and run in the kernel, may halt operations in the kernel upon receiving the interrupt, and may switch to a secure environment 612 at 604. For example, 604 may represent a context switch performed by BSP core 618, such as from a non-secure execution level (e.g., EL0 or EL1) to a secure execution level (e.g., EL3). BSP core 618 running in secure environment 612 may handle the interrupt that it received at 602, such as sending an acknowledgment to secure monitoring component 616.

At 606, BSP core 618 running in secure environment 612 may send one or more interrupts (e.g., IPIs) to one or more additional processor cores 614. Additional processor core(s) 614 may correspond to one or more of processor cores 112 of FIG. 1, and may represent all active processor cores in the system other than BSP core 618. One or more of additional processor core(s) 614 may respond to BSP core 618 with an acknowledgment of such an interrupt at 608. In some embodiments, each BSP core 618 that is in a healthy state, upon receiving an interrupt from BSP core 618 running in secure environment 612, halts execution in the kernel, switches to a secure environment (e.g., secure environment 612), and sends an acknowledgment of the interrupt while executing in the secure environment. Each such additional processor core 614 may then resume operations in the kernel.

If BSP core 618 and all of additional processor core(s) 614 acknowledge the corresponding interrupts (e.g., before expiration of the bite timer), then, at 610, BSP core 618 running in secure environment 612 may reset the bark timer and, in some embodiments, the bite timer (or BSP core 618 running in secure environment 612 may notify secure monitoring component 616 that all cores have responded and secure monitoring component 616 may reset the timer(s)), BSP core 618 may switch back to its prior execution level (e.g., a context switch from EL3 to EL0 or EL1) at 620, resuming execution in the kernel, and operations may proceed until the next expiration of the bark timer (at which point enhanced secure firmware implemented monitoring process 600 may be performed again).

If any core is unresponsive, then a fault handling process may be triggered by secure monitoring component 616 at 622. For example, if BSP core 618 does not respond to the interrupt sent at 602 with an acknowledgment and/or if one or more of additional core(s) 614 do not respond to a corresponding interrupt sent at 606 with an acknowledgment (e.g., BSP core 618 running in secure environment 612 may notify secure monitoring component 616 of any such acknowledgments) before expiration of a bite timer, then secure monitoring component 616 may trigger fault handling 618 at 622, which may involve resetting the system and/or notifying one or more other components that perform fault handling operations. For example, the bite timer may be started at the same time as the bark time and may be longer than the bark timer (or may be started at the time the bark timer expires). In other aspects, secure monitoring component 616 may trigger fault handling 618 prior to expiration of the bite timer if one or more cores do not respond to one or more corresponding interrupts within a threshold amount of time.

Enhanced secure firmware implemented monitoring process 600 enables monitoring of all active cores in a system at a secure execution level and in a resource-efficient manner, avoiding the need for redundant monitoring of cores by multiple VMs, and avoiding the monitoring gaps that exist in techniques that involve monitoring of all active cores at a non-secure execution level.

Additionally, because enhanced secure firmware implemented monitoring process 600 is performed at a secure execution level, tampering with such a monitoring process may be more challenging. For example, performing health monitoring of all active processor cores at a secure firmware level may enable monitoring a system for compliance with licenses or other restrictions that limit the number of active cores while preventing such monitoring from being tampered with or otherwise disabled. In an example use case, secure monitoring component 616 may determine whether the number of active cores in the system exceeds a maximum permitted number of active cores for the system (e.g., which may be indicated in configuration information, license information, or other information associated with the system, a user of the system, and/or another entity related to the system) and, if the maximum permitted number of active cores is exceeded, secure monitoring component 616 may trigger one or more preventive actions. Preventive actions may include, for example, shutting down the system, disabling certain functionality, powering down one or more active cores (e.g., powering down any active cores above the permitted maximum number), notifying one or more endpoints of a restriction violation, and/or the like.

### Example Method for Processor Health Monitoring

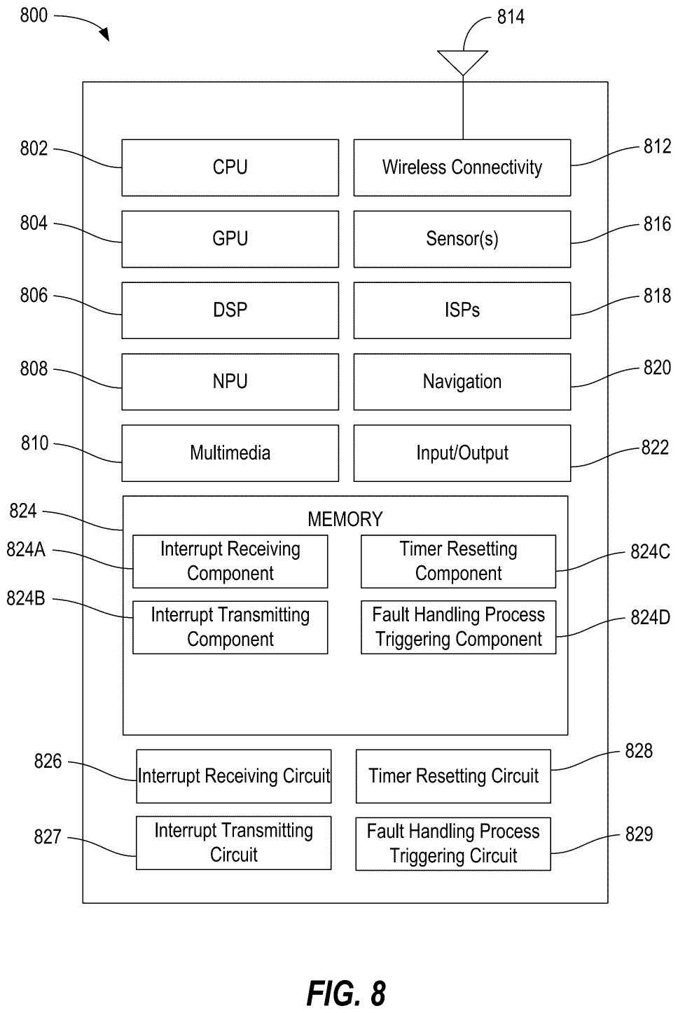

FIG. 7 is a flow diagram depicting an example method 700 for processor health monitoring according to various aspects of the present disclosure. For example, method 700 may be performed by one or more components of system 100 of FIG. 1, one or more components described with respect to FIG. 5 or 6, and/or by processing system 800 of FIG. 8, described below.

Method 700 begins at block 705, with receiving, by a bootstrap processor (BSP) core of a computing system after expiration of a timer, an interrupt from a monitoring component executing in secure firmware of the computing system.

Method 700 continues at block 710, with transmitting, by the BSP core based on the receiving of the interrupt, interrupts to a plurality of processor cores of the computing system.

Method 700 continues at block 715, with resetting the timer if the BSP core receives acknowledgments from the plurality of processor cores in response to the interrupts.

Method 700 continues at block 720, with triggering a fault handling process if the BSP core does not receive an acknowledgment from one of the plurality of processor cores.

In some embodiments the monitoring component executing in the secure firmware of the computing system and the BSP core run at a secure execution level.

In certain embodiments, the BSP core does not receive an acknowledgment from a given processor core of the plurality of processor cores, and the triggering of the fault handling process comprises resetting the computing system.

In some embodiments, the triggering of the fault handling process further comprises saving a current system status prior to the resetting of the computing system.

In certain embodiments, the interrupt received by the BSP core is a shared peripheral interrupt (SPI), and wherein the interrupts transmitted to the plurality of processor cores are inter-processor interrupts (IPIs).

Some embodiments further comprise halting, by the BSP core, operations in a kernel of the computing system and switching, by the BSP core, to a secure execution environment, wherein the transmitting of the interrupts to the plurality of processor cores occurs after the halting and the switching.

In certain embodiments, a given processor core of the plurality of processor cores, upon receiving a given interrupt of the interrupts from the BSP core, halts execution in the kernel, switches to a corresponding secure execution environment, and sends an acknowledgment of the given interrupt to the BSP core.

Some embodiments further comprise resuming, by the BSP core, the operations in the kernel if the BSP core receives the acknowledgments from the plurality of processor cores in response to the interrupts.

In certain embodiments, the computing system is a system-on-a-chip (SoC).

In some embodiments, virtual machines running on the plurality of processor cores do not independently monitor health of the plurality of processor cores.

Certain embodiments further comprise determining, by the monitoring component, whether a number of the plurality of processor cores complies with a processor core limit for the computing system.

Method 700 allows for efficient secure monitoring of processor cores in a system while avoiding redundant monitoring and enabling issues that occur at non-secure and secure levels to be detected and addressed.

### Example Processing System for Processor Health Monitoring

In some aspects, the workflows, techniques, and methods described with reference to FIGS. 1-7 may be implemented on one or more devices or systems. FIG. 8 depicts an example processing system 800 configured to perform various aspects of the present disclosure, including, for example, the techniques and methods described with respect to FIGS. 1-7. In some aspects, the processing system 800 may correspond to system 100 of FIG. 1. Although depicted as a single system for conceptual clarity, in some aspects, as discussed above, the operations described below with respect to the processing system 800 may be distributed across any number of devices or systems.

The processing system 800 includes a central processing unit (CPU) 802, which in some examples may be a multi-core CPU (e.g., corresponding to processor cores 112 of FIG. 1). Instructions executed at the CPU 802 may be loaded, for example, from a program memory associated with the CPU 802 or may be loaded from a memory partition (e.g., a partition of memory 824).

The processing system 800 also includes additional processing components tailored to specific functions, such as a graphics processing unit (GPU) 804, a digital signal processor (DSP) 806, a neural processing unit (NPU) 808, a multimedia component 810 (e.g., a multimedia processing unit), and a wireless connectivity component 812.

An NPU, such as NPU 808, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 808, are configured to accelerate the performance of common machine learning tasks, such as image classification, machine translation, object detection, and various other predictive models. In some examples, a plurality of NPUs may be instantiated on a single chip, such as a SoC, while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, the NPU 808 is a part of one or more of the CPU 802, the GPU 804, and/or the DSP 806. One or more of NPU 808, CPU 802, GPU 804, and/or DSP 806 may comprise one or more of processor cores 112 of FIG. 1.

In some examples, the wireless connectivity component 812 may include subcomponents, for example, for third generation (3G) connectivity, fourth generation (4G) connectivity (e.g., 4G Long-Term Evolution (LTE)), fifth generation connectivity (e.g., 5G or New Radio (NR)), Wi-Fi connectivity, Bluetooth connectivity, and/or other wireless data transmission standards. The wireless connectivity component 812 is further coupled to one or more antennas 814.

The processing system 800 may also include one or more sensor processing units 816 associated with any manner of sensor, one or more image signal processors (ISPs) 818 associated with any manner of image sensor, and/or a navigation processor 820, which may include satellite-based positioning system components (e.g., GPS or GLONASS), as well as inertial positioning system components.

The processing system 800 may also include one or more input and/or output devices 822, such as screens, touch-sensitive surfaces (including touch-sensitive displays), physical buttons, speakers, microphones, and the like.

In some examples, one or more of the processors of the processing system 800 may be based on an ARM or RISC-V instruction set.

The processing system 800 also includes the memory 824, which is representative of one or more static and/or dynamic memories, such as a dynamic random access memory, a flash-based static memory, and the like. In this example, the memory 824 includes computer-executable components, which may be executed by one or more of the aforementioned processors of the processing system 800.

In particular, in this example, the memory 824 includes an interrupt receiving component 1024A, an interrupt transmitting component 1024B, a timer resetting component 1024C, and a fault handling process triggering component 824D. Though depicted as discrete components for conceptual clarity in FIG. 8 the illustrated components (and others not depicted) may be collectively or individually implemented in various aspects.

The processing system 800 further comprises an interrupt receiving circuit 826, an interrupt transmitting circuit 827, a timer resetting circuit 828, and a fault handling process triggering circuit 829. The depicted circuits, and others not depicted, may be configured to perform various aspects of the techniques described herein.

For example, the interrupt receiving component 824A and/or the interrupt receiving circuit 826 may be used to receive, by a bootstrap processor (BSP) core of a computing system after expiration of a timer, an interrupt from a monitoring component executing in secure firmware of the computing system, as discussed above with respect to FIGS. 1-7.

The interrupt transmitting component 824B and/or interrupt transmitting circuit 827 may be used to transmit, by the BSP core based on the receiving of the interrupt, interrupts to a plurality of processor cores of the computing system, as described above with respect to FIGS. 1-7.

The timer resetting component 824C and/or the timer resetting circuit 828 may be used to reset the timer if the BSP core receives acknowledgments from the plurality of processor cores in response to the interrupts, as described above with respect to FIGS. 1-7.

The fault handling process triggering component 824D and/or the fault handling process triggering circuit 829 may be used to trigger a fault handling process if the BSP core does not receive an acknowledgment from one of the plurality of processor cores, as described above with respect to FIGS. 1-7.

Though depicted as separate components and circuits for clarity in FIG. 8, the interrupt receiving circuit 826, the interrupt transmitting circuit 827, the timer resetting circuit 828, and the fault handling process triggering circuit 829 may collectively or individually be implemented in other processing devices of the processing system 800, such as within the CPU 802, the GPU 804, the DSP 806, the NPU 808, and the like. For example, the interrupt receiving circuit 826, the interrupt transmitting circuit 827, the timer resetting circuit 828, and the fault handling process triggering circuit 829 may be implemented via one or more instructions in an instruction set of the CPU 802, the GPU 804, the DSP 806, the NPU 808, or the like.

Generally, the processing system 800 and/or components thereof may be configured to perform the methods described herein.

Notably, in other aspects, elements of the processing system 800 may be omitted, such as where the processing system 800 is a server computer or the like. For example, the multimedia component 810, the wireless connectivity component 812, the sensor processing units 816, the ISPs 818, and/or the navigation processor 820 may be omitted in other aspects. Further, aspects of the processing system 800 may be distributed between multiple devices.

### Example Clauses

Implementation examples are described in the following numbered clauses:

Clause 1: A method for processor health monitoring, comprising: receiving, by a bootstrap processor (BSP) core of a computing system after expiration of a timer, an interrupt from a monitoring component executing in secure firmware of the computing system; transmitting, by the BSP core based on the receiving of the interrupt, interrupts to a plurality of processor cores of the computing system; and performing, by the BSP core, one of: resetting the timer if the BSP core receives acknowledgments from the plurality of processor cores in response to the interrupts; or triggering a fault handling process if the BSP core does not receive an acknowledgment from one of the plurality of processor cores.

Clause 2: The method of Clause 1, wherein the monitoring component executing in the secure firmware of the computing system and the BSP core run at a secure execution level.

Clause 3: The method of any one of Clause 1-2, wherein the BSP core does not receive an acknowledgment from a given processor core of the plurality of processor cores, and wherein the triggering of the fault handling process comprises resetting the computing system.

Clause 4: The method of Clause 3, wherein the triggering of the fault handling process further comprises saving a current system status prior to the resetting of the computing system.

Clause 5: The method of any one of Clause 1-4, wherein the interrupt received by the BSP core is a shared peripheral interrupt (SPI), and wherein the interrupts transmitted to the plurality of processor cores are inter-processor interrupts (IPIs).

Clause 6: The method of any one of Clause 1-5, further comprising: halting, by the BSP core, operations in a kernel of the computing system; and switching, by the BSP core, to a secure execution environment, wherein the transmitting of the interrupts to the plurality of processor cores occurs after the halting and the switching.

Clause 7: The method of Clause 6, wherein a given processor core of the plurality of processor cores, upon receiving a given interrupt of the interrupts from the BSP core, halts execution in the kernel, switches to a corresponding secure execution environment, and sends an acknowledgment of the given interrupt to the BSP core.

Clause 8: The method of any one of Clause 6-7, further comprising resuming, by the BSP core, the operations in the kernel if the BSP core receives the acknowledgments from the plurality of processor cores in response to the interrupts.

Clause 9: The method of any one of Clause 1-8, wherein the computing system is a system-on-a-chip (SoC).

Clause 10: The method of any one of Clause 1-9, wherein virtual machines running on the plurality of processor cores do not independently monitor health of the plurality of processor cores.

Clause 11: The method of any one of Clause 1-10, further comprising determining, by the monitoring component, whether a number of the plurality of processor cores complies with a processor core limit for the computing system.

Clause 12: A processing system comprising: one or more memories comprising processor-executable instructions; and one or more processors configured to execute the processor-executable instructions and cause the processing system to: receive, by a bootstrap processor (BSP) core of a computing system after expiration of a timer, an interrupt from a monitoring component executing in secure firmware of the computing system; transmit, by the BSP core based on the receiving of the interrupt, interrupts to a plurality of processor cores of the computing system; and perform, by the BSP core, one of: resetting the timer if the BSP core receives acknowledgments from the plurality of processor cores in response to the interrupts; or triggering a fault handling process if the BSP core does not receive an acknowledgment from one of the plurality of processor cores.

Clause 13: The processing system of Clause 12, wherein the monitoring component executing in the secure firmware of the computing system and the BSP core run at a secure execution level.

Clause 14: The processing system of any one of Clause 12-13, wherein the BSP core does not receive an acknowledgment from a given processor core of the plurality of processor cores, and wherein the triggering of the fault handling process comprises resetting the computing system.

Clause 15: The processing system of Clause 14, wherein the triggering of the fault handling process further comprises saving a current system status prior to the resetting of the computing system.

Clause 16: The processing system of any one of Clause 12-15, wherein the interrupt received by the BSP core is a shared peripheral interrupt (SPI), and wherein the interrupts transmitted to the plurality of processor cores are inter-processor interrupts (IPIs).

Clause 17: The processing system of any one of Clause 12-116, wherein the one or more processors are further configured to execute the processor-executable instructions and cause the processing system to: halt, by the BSP core, operations in a kernel of the computing system; and switch, by the BSP core, to a secure execution environment, wherein the transmitting of the interrupts to the plurality of processor cores occurs after the halting and the switching.

Clause 18: The processing system of Clause 17, wherein a given processor core of the plurality of processor cores, upon receiving a given interrupt of the interrupts from the BSP core, halts execution in the kernel, switches to a corresponding secure execution environment, and sends an acknowledgment of the given interrupt to the BSP core.

Clause 19: The processing system of any one of Clause 17-18, further comprising resuming, by the BSP core, the operations in the kernel if the BSP core receives the acknowledgments from the plurality of processor cores in response to the interrupts.

Clause 20: An apparatus, comprising: means for receiving, by a bootstrap processor (BSP) core of a computing system after expiration of a timer, an interrupt from a monitoring component executing in secure firmware of the computing system; means for transmitting, by the BSP core based on the receiving of the interrupt, interrupts to a plurality of processor cores of the computing system; and means for performing, by the BSP core, one of: resetting the timer if the BSP core receives acknowledgments from the plurality of processor cores in response to the interrupts; or triggering a fault handling process if the BSP core does not receive an acknowledgment from one of the plurality of processor cores.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration. ” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining”may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more. ” Unless specifically stated otherwise, the term “some” refers to one or more. No claim element is to be construed under the provisions of 35 U.S.C. § 212(f) unless the element is expressly recited using the phrase “means for” or, in the case of a method claim, the element is recited using the phrase “step for. ” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for processor health monitoring, comprising:
receiving, by a bootstrap processor (BSP) core of a computing system after expiration of a timer, an interrupt from a monitoring component executing in secure firmware of the computing system;
transmitting, by the BSP core based on the receiving of the interrupt, interrupts to a plurality of processor cores of the computing system; and
performing, by the BSP core, one of:
resetting the timer if the BSP core receives acknowledgments from the plurality of processor cores in response to the interrupts; or
triggering a fault handling process if the BSP core does not receive an acknowledgment from one of the plurality of processor cores.

2. The method of claim 1, wherein the monitoring component executing in the secure firmware of the computing system and the BSP core run at a secure execution level.

3. The method of claim 1, wherein the BSP core does not receive an acknowledgment from a given processor core of the plurality of processor cores, and wherein the triggering of the fault handling process comprises resetting the computing system.

4. The method of claim 3, wherein the triggering of the fault handling process further comprises saving a current system status prior to the resetting of the computing system.

5. The method of claim 1, wherein the interrupt received by the BSP core is a shared peripheral interrupt (SPI), and wherein the interrupts transmitted to the plurality of processor cores are inter-processor interrupts (IPIs).

6. The method of claim 1, further comprising:
halting, by the BSP core, operations in a kernel of the computing system; and
switching, by the BSP core, to a secure execution environment, wherein the transmitting of the interrupts to the plurality of processor cores occurs after the halting and the switching.

7. The method of claim 6, wherein a given processor core of the plurality of processor cores, upon receiving a given interrupt of the interrupts from the BSP core, halts execution in the kernel, switches to a corresponding secure execution environment, and sends an acknowledgment of the given interrupt to the BSP core.

8. The method of claim 6, further comprising resuming, by the BSP core, the operations in the kernel if the BSP core receives the acknowledgments from the plurality of processor cores in response to the interrupts.

9. The method of claim 1, wherein the computing system is a system-on-a-chip (SoC).

10. The method of claim 1, wherein virtual machines running on the plurality of processor cores do not independently monitor health of the plurality of processor cores.

11. The method of claim 1, further comprising determining, by the monitoring component, whether a number of the plurality of processor cores complies with a processor core limit for the computing system.

12. A processing system comprising:
one or more memories comprising processor-executable instructions; and
one or more processors configured to execute the processor-executable instructions and cause the processing system to:
receive, by a bootstrap processor (BSP) core of a computing system after expiration of a timer, an interrupt from a monitoring component executing in secure firmware of the computing system;
transmit, by the BSP core based on the receiving of the interrupt, interrupts to a plurality of processor cores of the computing system; and
perform, by the BSP core, one of:
resetting the timer if the BSP core receives acknowledgments from the plurality of processor cores in response to the interrupts; or
triggering a fault handling process if the BSP core does not receive an acknowledgment from one of the plurality of processor cores.

13. The processing system of claim 12, wherein the monitoring component executing in the secure firmware of the computing system and the BSP core run at a secure execution level.

14. The processing system of claim 12, wherein the BSP core does not receive an acknowledgment from a given processor core of the plurality of processor cores, and wherein the triggering of the fault handling process comprises resetting the computing system.

15. The processing system of claim 14, wherein the triggering of the fault handling process further comprises saving a current system status prior to the resetting of the computing system.

16. The processing system of claim 12, wherein the interrupt received by the BSP core is a shared peripheral interrupt (SPI), and wherein the interrupts transmitted to the plurality of processor cores are inter-processor interrupts (IPIs).

17. The processing system of claim 12, wherein the one or more processors are further configured to execute the processor-executable instructions and cause the processing system to:
halt, by the BSP core, operations in a kernel of the computing system; and
switch, by the BSP core, to a secure execution environment, wherein the transmitting of the interrupts to the plurality of processor cores occurs after the halting and the switching.

18. The processing system of claim 17, wherein a given processor core of the plurality of processor cores, upon receiving a given interrupt of the interrupts from the BSP core, halts execution in the kernel, switches to a corresponding secure execution environment, and sends an acknowledgment of the given interrupt to the BSP core.

19. The processing system of claim 17, further comprising resuming, by the BSP core, the operations in the kernel if the BSP core receives the acknowledgments from the plurality of processor cores in response to the interrupts.

20. An apparatus, comprising:
means for receiving, by a bootstrap processor (BSP) core of a computing system after expiration of a timer, an interrupt from a monitoring component executing in secure firmware of the computing system;
means for transmitting, by the BSP core based on the receiving of the interrupt, interrupts to a plurality of processor cores of the computing system; and
means for performing, by the BSP core, one of:
resetting the timer if the BSP core receives acknowledgments from the plurality of processor cores in response to the interrupts; or
triggering a fault handling process if the BSP core does not receive an acknowledgment from one of the plurality of processor cores.
